(19) United States
(12) Patent Application Publication
(10) Pub. No.: US 2010/0311900 A1
(43) Pub. Date: Dec. 9, 2010

(54) THERMALLY STABLE MATRIX MICROPARTICLES AND MICROCAPSULES FOR POLYMER ADDITIZATION AND PROCESS FOR THEIR PRODUCTION

(75) Inventors: Jacqueline Lang, Berlin (DE); Gerald Rafler, Potsdam (DE)

Correspondence Address: BARNES & THORNBURG LLP, 11 SOUTH MERIDIAN, INDIANAPOLIS, IN, 46204, US

(73) Assignee: FRAUNHOFER-GESELLSCHAFT ZUR FORDERUNG DER ANGEWANDTEN FORSCHUNG E.V., München (DE)

(21) Appl. No.: 12/294,757

(22) PCT Filed: Mar. 27, 2007
(86) PCT No.: PCT/EP2007/002694

§ 371 Date: Mar. 5, 2009

(30) Foreign Application Priority Data
Apr. 6, 2006 (DE) 10 2006 016 307.9

(51) Int. Cl. C08L 79/08; C08G 73/10

(52) U.S. Cl. 524/606; 528/322; 428/402; 428/407

(57) ABSTRACT

Polyimide matrix microparticles or microcapsules having a thermally stable polyimide wall or matrix and functional polymer additives as core materials. The polyimide matrix microparticles or microcapsules can be processed into high-melting polymers by melt compounding.

The invention relates to polyimide matrix microparticles or microcapsules having a thermally stable polyimide wall or matrix and functional plastic material additives as core materials which can be incorporated in high melting-point plastic materials by melt compounding. The particle parameters and also the thermal and mechanical stability of the matrix particles or microcapsules can be adjusted specifically via the polyimide structure and/or technological parameters of the particle formation (shearing, reaction conditions for the wall formation). Microparticles made of polyimides and microencapsulated plastic material additives with a simply or complexly constructed particle wall made of polyimides are suitable above all for the production of specially finished polyamides, polyesters and high performance plastic materials, the processing of which requires high temperatures or which are used at high temperatures.

Thermoplastic and duromer polymer materials are adapted in a multiplicity of ways by means of inert fillers and/or functional additives to special requirements of use. The optimizations sought by means of additivation frequently relate both to the mechanical material properties directly (tensile and bending strength, toughness, modulus) and also to further properties of use of the materials, such as light and heat stability, flexibility or burning behaviour. Colourants are also frequently added to plastic materials. In the case of smart materials, more recent developments use plastic materials also as matrices for thermochromic or photochromic or respectively sensory substances and also for absorbing heat storing materials. Plastic material additives must fulfil a series of criteria which crucially jointly determine, in addition to the actual operational effect, the type and limits of use thereof. These are for example agglomerate-free dispersability, compatibility with the polymer matrix, inert behaviour relative to the undamaged polymer matrix, low migration rate etc. In the case of most mass plastic materials, such as polyolefins or vinyl polymers, the predominant number of additives used fulfil these prerequisites. In the case of selected higher priced and many high performance plastic materials, the use of additives is however limited as a result of high compounding and moulding temperatures. Also corrosive conditions of use can influence the stability of additives. By this route, effects on matrix stability via degradation products cannot then be precluded (cf. for example W. Hohenberger, Plastic Materials 92 (2002) H 5, p. 86).

In order to avoid or minimize
permeability in the polymer matrix
the lack of compatibility with the polymer matrix
the lack of compatibility with other components or additives of the polymer material
sensitivity to matrix or environmental influences
formation of degradation products
difficult dispersability in the polymer matrix
   an efficient method which can be used in a versatile manner is made available with the microencapsulation thereof, which method is used for covering microparticulate solids, finely distributed liquids or wax-like materials. Applications are known in agriculture and forestry, in products of the food, cosmetics, packaging, construction and varnish and paint industry. Use thereof is effected as dispersions, free-flowing powders or also by direct incorporation in other materials, in particular in diverse thermoplastic, elastomer and duromer polymer materials.

The microencapsulation with polymer materials is generally known and described extensively in the scientific and patent literature, such as e.g. in Encyclopaedia of Polymer Science, J. Wiley 86 Sons, 1968, Vol. 8, p. 719; W. Sliwka, App. Chem. Internat. Edit. 14 (1975) 539; Acta Polymerica 40 (1989) 243; 40 (1989) 325; KONA 10 (1992) 65; Drugs Pharm. Sci. 73 (1996) Microencapsulation 1; R. E. Sparks, Microencapsulation in Encyclopaedia of Chemical Processing, p. 162.

In the case of encapsulation technologies, a differentiation should be made in principle between reactive methods with monomers or prepolymers and also non-reactive particle formation processes with native or synthetic polymers. In the case of reactive particle formation, the formation of the wall is effected in parallel with a polymerization, polycondensation or polyaddition process. In the case of non-reactive methods, film-forming polymers are used directly and are brought by a thermodynamic manner to phase separation and to particle formation (cf. for example M. Jobmann, G. Rafter: Pharm. Ind. 60 (1998) 979 and the literature cited there). In addition, an active substance/polymer system is converted into a particulate form from preferably organic solution by dispersing, dropping or spraying processes or via methods which are based on the principle of liquid-liquid phase separation. Dispersing, dropping and spraying methods comprise solvent evaporation; on the other hand, phase separation methods are based on the principle of precipitation of the wall material, e.g. by addition of an incompatible component to the polymer solution.

The range of suitable polymers for non-reactive encapsulation processes, which are soluble in organic or aqueous phases, is wide. Since solubility of the polymer phase is an indispensable prerequisite for the non-reactive particle formation, generally only linear-chain or slightly branched polymers can be used. This has the effect that these microparticles, because of melting or softening, in many cases have only low thermostability. Frequently mentioned raw materials are gelatines, cellulose ether and also polyacrylates and polymethacrylates (cf. R. E. Sparks, I. C. Jacobs, N. S. Mason “Microencapsulation” in Drug Manufacturing Technology, Vol. 3 (1999) 13).

For reactive methods for encapsulation of solid or liquid core materials, melamine formaldehyde resins are very frequently used (DE 199 23 202; UK 2 301 117), but also isocyanate/amine systems are described (AZ 101 56 672). Melamine formaldehyde resins can be used widely and without difficulty for covering hydrophobic core materials and they can be applied for particle formation from the aqueous phase. Reactive methods require core materials which are inert relative to the wall-building monomers or oligomers, i.e. they do not undergo a reaction with other involved components.

In the case of both modes of operation, the application-relevant microparticle parameters, such as particle size and distribution thereof, form and morphology of the particles and the surface thereof, are determined in a complex manner by the chemical structure of the polymer phase of particle wall or matrix and also by the reaction conditions of the particle formation. Control parameters for particle geometry and particle morphology are above all duration and intensity of the dispersion, solution and interface properties of wall- and core material and also structure of the wall- or matrix-forming polymer material. In general, spherical microparticles with diameters between and 150 μm are formed. For low monomer or polymer concentrations using highly shearing dispersion tools, also particles with diameters <1 μm can be produced (EP 0 653 444).

The predominant majority of known thermoplastic and duromer wall materials, because of the meltability thereof or lack of thermal stability, are limited in their applicability for the production of microencapsulated additives for industrial plastic materials with their high processing temperatures of 240 to 280° C. Thermostable and temperature-stable plastic materials, such as polyaramides, polyether ketones, polysulphones or polyphenylene sulphide are, as a result of their chemical structure, frequently not soluble in normal organic solvents, such as are used for particle formation processes. Solvents for these heat resistant and thermostable polymers require complex encapsulation techniques, are difficult to remove from the particles because of high boiling points or limited miscibility with low-boiling extraction means or they dissolve or react with the core materials. Thermostable wall materials made of linear-chain polymers with solubility in solvents which are normal for particle methods are little known. There should be mentioned above all polyacrylnitrile and cellulose ether. In fact these polymers do not melt but their thermal stressability is likewise limited. Thus in DE 10 231 706, an encapsulation process for plastic material additives with polyacrylnitrile is described.

Polyimides have jointly, in addition to polybenzimidazoles and polyoxadiazoles, of all organic polymer materials, the highest thermal and chemical stability. Because of the known solubility problems which these polymer materials present, they have been unable to date to be used for microencapsulation of active substances.

The object underlying the invention is to produce microcapsules or micromatrix particles of high mechanical and thermal stability for the plastic material additivation according to an efficient and reliable in situ process.

The invention is achieved for the matrix microcapsules or matrix microparticles of high mechanical and thermal stability by the features of claim 1 and for the method of production thereof by the features of claim 16. Uses according to the invention of the method are characterized by the features of claim 45. The respective sub-claims contain advantageous developments for the microcapsules or for the method.

According to the invention, the microcapsules or micromatrix particles of high mechanical and thermal stability comprise a polyimide which forms the particle wall in the case of a capsule and the entire microparticle in the case of matrix particles.

If necessary, further functional plastic material additives can be incorporated both in the matrix microparticle and in the -microcapsule. Flame retardants, colour pigments, metal flakes and/or -powder, matting agents and phase change materials are thereby used preferably as additives.

The polyimide particles according to the invention have a monomodal particle distribution, with the avoidance of agglomeration, with an average diameter of 1 and 50 μm, preferably between 2 and 40 μm, particularly between 5 and 30 μm. They display spherical geometry with slight structuring of the particle surface. A characteristic feature of polyimide-based microcapsules and -particles is their high thermal, thermooxidative and chemical stability, based on the chemical structure of the wall or matrix materials. As a function of the chemical structure, a notable mass loss, caused by thermolysis reactions, is observed thermogravimetrically, in a range of 450° C. to 530° C.

The matrix microparticles or -microcapsules based on polyimides have the advantageous property of being stable under inert conditions (nitrogen as inert gas) up to 500° C. and, in air, up to 350° C.

Preferred polyimides for the matrix microparticle formation or -microencapsulation are for example poly(4,4′-diphenyloxide pyromellitimide), poly(4,4′-diphenylmethane pyromellitimide), poly(4,4′-diphenyloxide diphthalimide), poly(m-phenylene isopropylidene diphthalimide), poly(2,2-dimethyl-4,4′-diphenylmethane pyromellitimide), poly(2,2-bis(trifluoromethyl)-4,4′-diphenylmethane oxydiphthalimide and poly(4,4′-diphenyloxide carbonyldiphthalimide).

The polyimide particles can have, from application-relevant aspects, dependent upon the requirement profile for the microencapsulated additives or microparticulate fillers, also a complex shell construction, the second or the third shell being able to be produced both from the same and from different materials. For structurally different shell materials, in addition to the polyimides, above all shells made of linear-chain polymers or from low-molecular organic or inorganic substances, such as waxes, fatty acid derivatives, silicones, siloxanes or silicates are preferred. There are included as polymers which are structurally different from the shell material and which are suitable particularly for the coating of polyimide microparticles, above all polyacrylates, polyethylene glycols and also starch-fatty acid esters and starch carbamates of long-chain isocyanates.

According to the invention, the polyimide particles with a core, shell or matrix structure are formed via a multi-stage method which comprises the steps
synthesis of the polyamidocarboxylic acids from the monomeric diamines and tetracarboxylic acid anhydrides,
particle formation or encapsulation with the soluble polyamidocarboxylic acid according to a coacervation or precipitation method,
isolation of the polyamidocarboxylic acid microparticles,
formation of the polyimide microparticles by thermal cyclization of the polyamidocarboxylic acid microparticles,
separation of the polyimide microparticles.

The formation of the polyamidocarboxylic acid particles is effected in the following method steps
1. Firstly, the solution of the polyamidocarboxylic acid is adjusted to the desired concentration and if necessary the plastic material additive is added or dispersed therein. A plastic material additive is thereby preferably used selected from the group comprising flame retardants, colour pigments, metal flakes and/or -powder, matting agents and phase change materials.
2. Subsequently, a stable viscous emulsion is produced by addition of an emulsion agent.
3. An extraction agent is added to the emulsion in order to remove the solvent with formation of the microcapsules or matrix microparticles.
4. The microcapsules or matrix microparticles are isolated by means of liquid-solid separation techniques.
5. Reclaiming and regeneration of the continuous media from the particle production.

For synthesis of the polyamidocarboxylic acids, in principle any aliphatic, aromatic and/or aliphatic-aromatic diamine can be made to react with an aliphatic, aromatic and/or aliphatic-aromatic tetracarboxylic acid derivative. There are possible as carboxylic acid derivatives hereby, carboxylic acid anhydrides, free carboxylic acid, carboxylic acid esters and carboxylic acid chlorides. Tetracarboxylic acid anhydrides and diamines which are used preferably for the encapsulation of solid and liquid core materials or the matrix particle formation with polyimides are above all 1,2,4,5-benzene tetracarboxylic acid-(=pyromellitic acid-), 3,3′-4,4′-biphenyltetracarboxylic acid-, 3,3′-4,4′-benzophenone tetracarboxylic acid-(=3,3′-4,4′-benzoylbenzoic tetracarboxylic acid-), 3,3′,-4,4′-isopropylidene diphthalic acid-, 3,3′-4,4′-oxydiphthalic acid- and (hexafluoroisopropylidine)diphthalic acid dianhydride in the case of tetracarboxylic acid dianhydrides and also m-phenylene diamine, 4,4′-diaminodiphenylmethane, 4,4′-diaminodiphenylether, 4,4′-diaminodiphenylsulphone and 2,2′-bis(4-aminophenyl)propane in the case of diamines.

As an alternative thereto, also even previously synthesized polyamidocarboxylic acids can be dissolved in one of the solvents described below.

In the synthesis, the monomers can be dissolved in solvents which are miscible with water. The solvents known for this synthesis of the amide type, such as dimethylacetamide and N-methylpyrrolidone, are used preferably. The solutions with the formed polyamidocarboxylic acids can be further processed directly into microparticles. Storage at temperatures below room temperature and with moisture exclusion is also possible. Under these conditions, the solutions are stable in storage for several weeks. For the further processing, dilution with the same solvent or even with a different solvent which is miscible with water is possible.

The concentration of the polymer solution is determined by chemical structure and molar mass of the polyamidocarboxylic acid. Both determine the viscosity of the polymer solution which in turn is responsible for the size and morphology of the microcapsules and matrix particles. Better soluble polyamidocarboxylic acids and higher molar masses are used with lower concentrations, not easily soluble ones and those with a lower molar mass require higher concentrations. The concentration of the polymer solution is in a range between 1 and 50% by weight, preferably between 2 and 20% by weight.

All emulsion agents are suitable for the production of the emulsion which have no or only limited miscibility with the solvent, do not react with the polyamidocarboxylic acid and represent a solvent neither for the polymer wall or matrix material nor the plastic material additive. For the mentioned reasons, above all vegetable and mineral oils are suitable for the production of an emulsion with corresponding viscosity, preferably silicone or paraffin oil. The polymer solution or additive suspension in the solution of the polymer is finely distributed in the emulsion agent by intensive mixing. With respect to the dissolved polymer, the emulsion agent is used in excess. It is thereby advantageous if the excess is between a multiple of two to ten, preferably between three to five, of the polymer.

The distribution of the additive-containing or additive-free polymer solution in the emulsion agent is assisted by addition of further organosoluble emulsifiers in a concentration between 0.1 and and 5% by weight, preferably between 0.5 and 2% by weight. At the same time, such emulsifiers also improve the stability of the emulsion and hence they assist also the formation of artefact-free microparticles. Preferred emulsifiers are non-ionogenic or anion-active substances, such as e.g. SPAN®85 or TWEEN®.

The extraction agent is added to the emulsion with agitation. The more slowly this addition is effected, the more intensive the contact for extraction of the polymer solvent and the lower the proportion of agglomerated particles. Single particle distributions facilitate separation, treating and possibly redispersion of the particles. According to the invention, preferably water or aqueous inorganic or organic phases are added as extraction agent. These extraction agents are miscible with the polyamidocarboxylic acid solvent in an unlimited manner and not miscible with the emulsion agent. At the same time, it must be ensured that the extraction agent does not represent a solvent for the polymer and the additive. The ratio between emulsion agent and extraction agent must be adjusted such that the polymer solvent is extracted completely. After formation of the microparticles by curing the particle wall or the particle matrix, these are isolated in a solid-liquid manner by means of normal phase separation methods. There are suitable above all centrifugation and filtration which permit problem-free washing of the particles for separation from the remaining emulsion agent.

For imidation of the polyamidocarboxylic acids, the isolated microcapsules or matrix particles are heated in the air- or inert gas glow or under vacuum for 0.5 to 10 hours, preferably 2 to 5 hours, to a temperature between 100 and 400° C., preferably between 100 and 300° C. The obtained polyimide particles can be used in this form as microfine powders directly for the thermoplastic additivation. For other fields of use, redispersion in aqueous or oil phases and application as a microfine suspension is also possible. Cyclization of the polyamidocarboxylic acid matrix particles, i.e. of microparticles with a relatively small particle size and monomodal particle size distribution by thermal cyclization of the polyamidocarboxylic acid matrix particles or microcapsules, can be effected also in suspension, high boiling-point media requiring to be used, in which the polyamidocarboxylic acids are insoluble. Above all high boiling-point hydrocarbons, fatty acid esters and silicone oils which can then be used directly as suspension or be separated are suitable. Furthermore, it is worthy of mention that this can be effected at a temperature above the boiling point of water but not substantially higher (100-150° C.), in a vacuum or with azeotropic distillation. This is possible above all for flame retardants such as melamine inter alia. The microparticles according to the invention with core-shell or matrix structure are used preferably as particulate fillers for improving the material properties of plastic materials. A further application resides in the introduction of plastic material additives into polymer materials. The microparticles according to the invention can be introduced, analogously to particulate fillers or additives, by means of twin-screw extruders or kneaders, into thermoplastic or duromer polymer materials and the additivated plastic materials are further processed by normal moulding methods, such as injection moulding or extrusion in the case of thermoplasts and by thermopressing in the case of duromers.

The subject according to the invention is intended to be explained in more detail with reference to the subsequent examples without wishing to restrict said subject to the embodiments mentioned here.

### EXAMPLE 1

### Synthesis of polyamidocarboxylic acid

0.1 mol 4,4′-diaminodiphenylether (20.02 g) are dissolved in 250 ml N-methylpyrrolidone. 250 ml of a solution of 0.1 mol 3,3′-4,4′-benzophenone tetracarboxylic acid anhydride (32.2 g) are added in drops to the diamine solution within 30 min with agitation at room temperature. For polycondensation of the tetracarboxylic acid anhydride with the diamine, agitation takes place for a further 6 h at room temperature. The solution of the polyamidocarboxylic acid is stored in the closed vessel at 5° C. until further processing in order to avoid uncontrolled secondary or subsequent reactions of the primary acylation reaction. For polymer characterization, a small quantity is removed and the polyamidocarboxylic acid precipitated in ethanol or water.

### EXAMPLES 2-7

### Synthesis of the polyamidocarboxylic acids

Analogously to example 1, the monomers compiled in Table 1 are combined and the obtained polyamidocarboxylic acids are used for microencapsulation and matrix particle formation.

TABLE 1
Polyamidocarboxylic acids for the production of polyimide-based
microparticles

| Example | Tetracarboxylic acid dianhydride | Diamine |
|---|---|---|
| 2 | pyromellitic acid dianhydride | 4,4′-diamino- |
| | | diphenylether |
| 3 | pyromellitic acid dianhydride | 4,4′-diamino- |
| | | diphenylmethane |
| 4 | 3,3′-4,4′-biphenyltetracarboxylic | 4,4′-diamino- |
| | acid dianhydride | diphenylether |
| 5 | 3,3′-4,4′-isopropylidene diphthalic | m-phenylenediamine |
| | acid dianhydride | |
| 6 | 3,3′-4,4′-oxydiphthalic acid | 2,2′-bis(4-amino- |
| | dianhydride | phenyl)propane |
| 7 | (hexafluoroisopropylidene)- | 2,2′-bis(4-amino- |
| | diphthalic acid dianhydride | phenyl)propane |

### EXAMPLE 8

### Microparticle Formation

6 ml of a 10% solution of poly(4,4′-diphenyloxide carbonyldiphthalic acid amide) (polyamidocarboxylic acid from example 1) in NMP are introduced into 60 ml paraffin oil with intensive agitation at 25° C. 120 ml water is subsequently added to the dispersion within 30 min. After the phase separation, 500 ml n-hexane are added to the upper oily phase, the particle suspension is separated, washed with hexane and ethanol and the separated particles are dried.

The average particle size was determined by means of laser diffraction.

Yield of polyamidocarboxylic acid particles: 0.48 g

Average particle size: d₅₀: 8.3 μm

### EXAMPLE 9

### Microparticle Formation

30 ml of a 10% solution of poly(4,4′-diphenyloxide carbonyldiphthalic acid amide) (polyamidocarboxylic acid from example 1) in NMP are introduced into 300 ml silicone oil with intensive agitation at 25° C. 600 ml water are added subsequently within 30 min to the dispersion. After the phase separation, 1200 ml n-hexane are added to the upper oily phase, the particle suspension is separated, washed with hexane and ethanol and the separated particles are dried.

Yield of polyamidocarboxylic acid particles: 2.81 g

Average particle size: d₅₀: 17.7 μm

### EXAMPLE 10-15

Analogously to example 8, respectively 10% NMP solutions of the polyamidocarboxylic acids (Examples 2-7) listed in Table 1 are processed into microparticles and treated. The obtained microparticles are listed in Table 2.

TABLE 2
Polyamidocarboxylic acid microparticles produced
according to the invention

| | Polyamidocarboxylic | | |
|---|---|---|---|
| Example | acid | Yield [g] | Size [μm] |
| 10 | poly(4,4′- | 0.43 | 12.2 |
| | diphenyloxide | | |
| | pyromellitic acid | | |
| | amide) | | |
| 11 | poly(4,4′- | 0.57 | 9.8 |
| | diphenylmethane | | |
| | pyromellitic acid | | |
| | amide) | | |
| 12 | poly(4,4′- | 0.46 | 8.3 |
| | diphenyloxide | | |
| | diphthalic acid amide) | | |
| 13 | poly(m-phenylene | 0.41 | 10.7 |
| | isopropylidene | | |
| | diphthalic acid amide) | | |
| 14 | poly(2,2-dimethyl- | 0.52 | 11.6 |
| | 4,4′-diphenylmethane | | |
| | pyromellitic acid | | |
| | amide) | | |
| 15 | poly(2,2- | 0.39 | 21.5 |
| | bis(trifluoromethyl)- | | |
| | 4,4′-diphenylmethane | | |
| | oxydiphthalic acid | | |
| | amide | | |

### EXAMPLE 16

25 g poly(4,4′-diphenyloxide carbonyldiphthalic acid amide) are dissolved in 250 ml DMAc. This polymer solution is introduced with intensive agitation into 300 ml paraffin oil at 25° C. 600 ml water are added subsequently within 30 min to the dispersion. After the phase separation, 1500 ml n-hexane are added to the upper oily phase, the particle suspension is separated, washed with hexane and ethanol and the separated particles are dried.

Yield of polyamidocarboxylic acid particles: 20 g

Average particle size: 13.9 μm

### EXAMPLE 17

### Microencapsulation

There are added to 40 ml of a 5% solution of poly(4,4′-diphenyloxide pyromellitic acid amide) (polymer example 2) in DMAc, 0.125 g TWEEN® 85 and 1.2 g titanium dioxide (Hüls AG). This titanium dioxide dispersion is added in drops to 60 ml paraffin oil with intensive agitation at 25° C. 120 ml water are added subsequently within 30 min to the dispersion. After the phase separation, 500 ml n-hexane are added to the upper oily phase, the microcapsule suspension is separated, washed with hexane and ethanol and the separated microcapsules are dried.

Yield of microencapsulated titanium dioxide: 2.8 g P Average microcapsule size: 3.8 μm

### Example 18

Analogously to example 17, 1 g AEROSIL R106 is microencapsulated and treated.

Yield of microencapsulated AEROSIL R106: 2.5 g

Average microcapsule size: 10.1 μm

### EXAMPLE 19

There are added to 40 ml of a 5% solution of poly(4,4′-diphenyloxide pyromellitic acid amide) (polymer example 2) in DMAc, 0.125 g TWEEN®85 and 5 g red phosphorus (Merck AG). This dispersion of red phosphorus in the solution of poly(4,4′-diphenyloxide pyromellitic acid amide) is added in drops to 60 ml paraffin oil with intensive agitation at 25° C. 120 ml of a water/acetone mixture (1:2) are added subsequently within 30 min to the dispersion. After the phase separation, 500 ml n-hexane are added to the upper oily phase, the microcapsule suspension is separated, washed with hexane and ethyl acetate and the separated microcapsules are dried.

Yield of microencapsulated red phosphorus: 6.1 g

Average microcapsule size: 10.2 μm

### EXAMPLES 20-23

The polyamidocarboxylic acid microparticles produced according to examples 8-13 are heated in a vacuum cabinet or circulating air drying cabinet for 5 h to 200° C. The polyimide microparticles produced in this way have the usage-relevant material- and particle parameters compiled in Table 3. The beginning of the thermal degradation T_{T} under an inert gas atmosphere was determined thermogravimetrically.

TABLE 3
Material- and particle parameters of polyimide microparticles
according to the invention

| Polyimide | Polyamidocarboxylic | | |
|---|---|---|---|
| corresponding | acid corresponding | Size | |
| to example | to example | [μm] | T_{T} [° C.] |
| 20 | 8 | 47.5 | 520 |
| 21 | 9 | 13.4 | 523 |
| 22 | 10 | 17.2 | 524 |
| 23 | 13 | 60.1 | 509 |

### EXAMPLES 24-25

The microencapsulated substances produced according to examples 17-18 are heated analogously to example 20-25 in the vacuum cabinet or circulating air drying cabinet for 5 h to 200° C. The polyimide microcapsules produced in this way have the usage-relevant material- and particle parameters compiled in Table 4.

TABLE 4
Material- and particle parameters of polyimide microcapsules
according to the invention

| | Microencapsulation | | |
|---|---|---|---|
| | corresponding to | Size | |
| Example | example | [μm] | T_{T} [° C.] |
| 24 | 17 | 4.2 | 426.2 |
| 25 | 18 | 38.2 | 508.9 |

1-45. (canceled)

46. At least one of matrix microparticles and microcapsules, the at least one of matrix microparticles and microcapsules constructed from thermally stable polyimide.

47. The at least one of matrix microparticles and microcapsules according to claim 46 wherein the thermally stable polyimide is at least one of a matrix additive of the matrix microparticles and a core material of the microcapsules.

48. The at least one of matrix microparticles and microcapsules according to claim 47 wherein the thermally stable polyimide includes at least one of a flame retardant, a color pigment, metal flakes, metal powder, a matting agent and a phase change material.

49. The at least one of matrix microparticles and microcapsules according to claim 46 wherein the average size of the at least one of matrix microparticles and microcapsules is between 1 and 50 μm.

50. The at least one of matrix microparticles and microcapsules according to claim 46 wherein the at least one of the matrix microparticle matrix and the microcapsule wall is stable under inert conditions up to 500° C. and, in air, up to 350° C.

51. The at least one of matrix microparticles and microcapsules according to claim 46 wherein the polyimide is produced by cyclization of a polyamidocarboxylic acid.

52. The at least one of matrix microparticles and microcapsules according to claim 51 wherein the polyamidocarboxylic acid is prepared by reaction of at least one of aliphatic diamines, aromatic diamines and aliphatic-aromatic diamines, aliphatic tetracarboxylic acid derivatives, aromatic tetracarboxylic acid derivatives and aliphatic-aromatic tetracarboxylic acid derivatives.

53. The at least one of matrix microparticles and microcapsules according to claim 52 wherein the at least one of aliphatic diamines, aromatic diamines, aliphatic-aromatic diamines, aliphatic tetracarboxylic acid derivatives, aromatic tetracarboxylic acid derivatives and aliphatic-aromatic tetracarboxylic acid derivatives comprise at least one of carboxylic acid anhydrides, free carboxylic acids, carboxylic acid esters and carboxylic acid chlorides.

54. The at least one of matrix microparticles and microcapsules according to claim 53 wherein the carboxylic acid anhydrides comprise at least one of 1,2,4,5-benzene tetracarboxylic acid dianhydride (pyromellitic acid dianhydride), 3,3′-4,4′-biphenyltetracarboxylic acid dianhydride, 3,3′-4,4′-benzoylbenzoic tetracarboxylic acid dianhydride (benzophenone tetracarboxylic acid dianhydride), 3,3′-4,4′-isopropylidene diphthalic acid dianhydride, 3,3′-4,4′-oxydiphthalic acid dianhydride and (hexafluoroisopropylidine)diphthalic acid dianhydride.

55. The at least one of matrix microparticles and microcapsules according to claim 52 wherein the diamines comprise at least one of m-phenylene diamine, 4,4′-diaminodiphenylmethane, 4,4′-diphenylether, 4,4′-diaminodiphenylsulphone and 2,2′-bis(4-aminophenyl)propane.

56. The at least one of matrix microparticles and microcapsules according to claim 46 wherein the polyimide is selected from the group consisting of poly(4,4′-diphenyloxide pyromellitimide), poly(4,4′-diphenylmethane pyromellitimide), poly(4,4′ diphenyloxide diphthalimide), poly(m-phenylene isopropylidene diphthalimide), poly(2,2-dimethyl-4,4′ diphenylmethane pyromellitimide), poly(2,2-bis(trifluoromethyl)-4,4′-diphenylmethane oxydiphthalimide and poly(4,4′ diphenyloxide carbonyldiphthalimide).

57. The at least one of matrix microparticles and microcapsules according to claim 52 wherein the at least one of matrix microparticles and microcapsules has a complex, multilayer shell construction.

58. The at least one of matrix microparticles and microcapsules according to claim 57 wherein the shells comprise at least one of the same material and a different material.

59. The at least one of matrix microparticles and microcapsules according to claim 57 wherein the shells comprise at least one of linear-chain polymers, low-molecular inorganic materials and low-molecular organic materials.

60. The at least one of matrix microparticles and microcapsules according to claim 59 wherein the at least one of low-molecular inorganic materials and low-molecular organic materials comprise at least one of waxes, fatty acid derivatives, silicones, siloxanes and silicates.

61. A method for the production of at least one of a thermally stable matrix microparticle and a thermally stable microcapsule having a capsule wall, the method comprising:
a) production of a solution of polyamidocarboxylic acids by reaction of monomeric diamines and tetracarboxylic acid derivatives or by dissolving polyamidocarboxylic acids in a solvent;
b) matrix microparticle formation or microencapsulation of the soluble polyamidocarboxylic acids according to a coacervation or precipitation method;
c) isolation of the polyamidocarboxylic acid matrix microparticles or microcapsules;
d) formation of the polyimide matrix microparticles or microcapsules of the polyamidocarboxylic acids; and,
e) separation of the polyimide matrix microparticles or microcapsules.

62. The method for the production of at least one of a thermally stable matrix microparticle and a thermally stable microcapsule according to claim 61 further including dispersing at least one functional plastic material additive into the solution between step a) and step b).

63. The method for the production of at least one of a thermally stable matrix microparticle and a thermally stable microcapsule according to claim 62 wherein dispersing at least one functional plastic material additive into the solution between step a) and step b) comprises dispersing at least one of a flame retardant, a color pigment, metal flakes, metal powder, a matting agent and a phase change material.

64. The method for the production of at least one of a thermally stable matrix microparticle and a thermally stable microcapsule according to claim 61 wherein producing at least one of a thermally stable matrix microparticle and a thermally stable microcapsule comprises producing at least one of a thermally stable matrix microparticle and a thermally stable microcapsule having an average size between 1 and 50 μm.

65. The method for the production of at least one of a thermally stable matrix microparticle and a thermally stable microcapsule according to claim 61 wherein producing a solution of polyamidocarboxylic acids by reaction of monomeric diamines and tetracarboxylic acid derivatives or by dissolving polyamidocarboxylic acids in a solvent includes preparing the polyamidocarboxylic acids by reaction of at least one of aliphatic diamines, aromatic diamines, aliphatic-aromatic diamines, aliphatic tetracarboxylic acid derivatives, aromatic tetracarboxylic acid derivatives and aliphatic-aromatic tetracarboxylic acid derivatives.

66. The method for the production of at least one of a thermally stable matrix microparticle and a thermally stable microcapsule according to claim 65 wherein producing a solution of polyamidocarboxylic acids by reaction of monomeric diamines and tetracarboxylic acid derivatives or by dissolving polyamidocarboxylic acids in a solvent includes preparing the polyamidocarboxylic acids by reaction of at least one of aliphatic diamines, aromatic diamines, aliphatic-aromatic diamines, aliphatic tetracarboxylic acid derivatives, aromatic tetracarboxylic acid derivatives and aliphatic-aromatic tetracarboxylic acid derivatives comprises producing a solution of polyamidocarboxylic acids by reaction of monomeric diamines and tetracarboxylic acid derivatives or by dissolving polyamidocarboxylic acids in a solvent includes preparing the polyamidocarboxylic acids by reaction of at least one of carboxylic acid anhydrides, free carboxylic acids, carboxylic acid esters and carboxylic acid chlorides.

67. The method for the production of at least one of a thermally stable matrix microparticle and a thermally stable microcapsule according to claim 66 wherein preparing the polyamidocarboxylic acids by reaction of at least one of carboxylic acid anhydrides, free carboxylic acids, carboxylic acid esters and carboxylic acid chlorides comprises preparing the polyamidocarboxylic acids by reaction of at least one of 1,2,4,5-benzene tetracarboxylic acid dianhydride (pyromellitic acid), 3,3′-4,4′-biphenyltetracarboxylic acid dianhydride, 3,3′,4,4′-benzoylbenzoic tetracarboxylic acid dianhydride (benzophenone tetracarboxylic acid), 3,3′-4,4′-isopropylidene-diphthalic acid dianhydride, 3,3′,4,4′-oxydiphthalic acid dianhydride and (hexafluoroisopropylidene)diphthalic acid dianhydride.

68. The method for the production of at least one of a thermally stable matrix microparticle and a thermally stable microcapsule according to claim 65 wherein preparing the polyamidocarboxylic acids by reaction of at least one of aliphatic diamines, aromatic diamines, aliphatic-aromatic diamines, aliphatic tetracarboxylic acid derivatives, aromatic tetracarboxylic acid derivatives and aliphatic-aromatic tetracarboxylic acid derivatives comprises preparing the polyamidocarboxylic acids by reaction of at least one of m-phenylene diamine, 4,4′-diaminodiphenylmethane, 4,4′-diaminodiphenylether, 4,4′-diaminodiphenylsulphone and 2,2′-bis(4-aminophenyl)propane.

69. The method for the production of at least one of a thermally stable matrix microparticle and a thermally stable microcapsule according to claim 61 wherein production of a solution of polyamidocarboxylic acids by reaction of monomeric diamines and tetracarboxylic acid derivatives or by dissolving polyamidocarboxylic acids in a solvent comprises dissolving polyamidocarboxylic acids in a solvent selected from the group consisting of organic solvents which are miscible with water.

70. The method for the production of at least one of a thermally stable matrix microparticle and a thermally stable microcapsule according to claim 69 wherein dissolving polyamidocarboxylic acids in a solvent selected from the group of organic solvents which are miscible with water comprises dissolving polyamidocarboxylic acids in a solvent selected from the group consisting of organic amides.

71. The method for the production of at least one of a thermally stable matrix microparticle and a thermally stable microcapsule according to claim 69 wherein dissolving polyamidocarboxylic acids in a solvent selected from the group consisting of organic solvents which are miscible with water comprises dissolving polyamidocarboxylic acids in at least one of dimethylformamide, dimethylacetamide and N-methylpyrrolidone.

72. The method for the production of at least one of a thermally stable matrix microparticle and a thermally stable microcapsule according to claim 61 further including adjusting the concentration of the polyamidocarboxylic acids between about 1% by weight and about 50% by weight.

73. The method for the production of at least one of a thermally stable matrix microparticle and a thermally stable microcapsule according to claim 61 further including before step b) adding a first emulsion agent and forming a stable viscous emulsion.

74. The method for the production of at least one of a thermally stable matrix microparticle and a thermally stable microcapsule according to claim 73 wherein adding a first emulsion agent comprises adding a first emulsion agent in a multiple of two to ten in excess to the solution of the polyamidocarboxylic acid.

75. The method for the production of at least one of a thermally stable matrix microparticle and a thermally stable microcapsule according to claim 73 wherein adding a first emulsion agent comprises adding a first emulsion agent having, at most, limited miscibility with the solvent.

76. The method for the production of at least one of a thermally stable matrix microparticle and a thermally stable microcapsule according to claim 73 wherein adding a first emulsion agent comprises adding a first emulsion agent selected from the group consisting of vegetable oils, mineral oils and synthetic oils.

77. The method for the production of at least one of a thermally stable matrix microparticle and a thermally stable microcapsule according to claim 73 wherein adding a first emulsion agent comprises adding at least one of silicone oil and paraffin oil.

78. The method for the production of at least one of a thermally stable matrix microparticle and a thermally stable microcapsule according to claim 73 further including before step b) adding a second emulsifier in a concentration between about 0.1% by weight and 5% by weight in order to assist the distribution of the polyamidocarboxylic acids in the first emulsion agent.

79. The method for the production of at least one of a thermally stable matrix microparticle and a thermally stable microcapsule according to claim 78 wherein adding a second emulsifier comprises adding a second emulsifier selected from the group consisting of non-ionogenic substances, anion-active substances, and mixtures of non-ionogenic substances and anion-active substances.

80. The method for the production of at least one of a thermally stable matrix microparticle and a thermally stable microcapsule according to claim 73 wherein adding a second emulsifier comprises adding at least one of TWEEN® and SPAN®85.

81. The method for the production of at least one of a thermally stable matrix microparticle and a thermally stable microcapsule according to claim 61 further including adding an extraction agent to extract the solvent.

82. The method for the production of at least one of a thermally stable matrix microparticle and a thermally stable microcapsule according to claim 78 wherein adding an extraction agent comprises adding at least one of water, aqueous organic phases, and aqueous inorganic phases.

83. The method for the production of at least one of a thermally stable matrix microparticle and a thermally stable microcapsule according to claim 61 wherein separation of the polyimide matrix microparticles or microcapsules comprises separation of the polyimide matrix microparticles or microcapsules by liquid-solid separation.

84. The method for the production of at least one of a thermally stable matrix microparticle and a thermally stable microcapsule according to claim 83 wherein separation of the polyimide matrix microparticles or microcapsules by liquid-solid separation comprises separation of the polyimide matrix microparticles or microcapsules by at least one of centrifugation and filtration.

85. The method for the production of at least one of a thermally stable matrix microparticle and a thermally stable microcapsule according to claim 61 wherein formation of the polyimide matrix microparticles or microcapsules of the polyamidocarboxylic acids comprises thermal cycling of the polyamidocarboxylic acids.

86. The method for the production of at least one of a thermally stable matrix microparticle and a thermally stable microcapsule according to claim 85 wherein thermal cycling of the polyamidocarboxylic acids comprises thermal cycling of the polyamidocarboxylic acids under vacuum.

87. The method for the production of at least one of a then ally stable matrix microparticle and a thermally stable microcapsule according to claim 85 wherein thermal cycling of the polyamidocarboxylic acids comprises thermal cycling of the polyamidocarboxylic acids between about 100° C. and about 400° C.

88. The method for the production of at least one of a thermally stable matrix microparticle and a thermally stable microcapsule according to claim 85 wherein thermal cycling of the polyamidocarboxylic acids comprises thermal cycling of the polyamidocarboxylic acids for between about 0.5 hour and about 10 hours.

89. The method for the production of at least one of a thermally stable matrix microparticle and a thermally stable microcapsule according to claim 61 further including reclaiming and regenerating continuous media from the production of at least one of a thermally stable matrix microparticle and a thermally stable microcapsule.

90. At least one of thermally highly-stressable plastic materials, mechanically highly-stressable plastic materials, fillers for thermally highly-stressable plastic materials, fillers for mechanically highly-stressable plastic materials, additives for thermally highly-stressable plastic materials, and additives for mechanically highly-stressable plastic materials comprising at least one of matrix microparticles and microcapsules constructed from thermally stable polyimide.
